(19) United States
(12) Patent Application Publication
(10) Pub. No.: US 2017/0361812 A1
(43) Pub. Date: Dec. 21, 2017

(54) CONTAINED FLUID APPLICATION SYSTEM

(71) Applicant: Hydro Engineering Equipment and Supply Co., LLP, Salt Lake City, UT (US)

(72) Inventors: James P. McCormick, Sandy, UT (US); Alan G. McCormick, Sandy, UT (US)

(73) Assignee: Hydro Engineering Equipment and Supply Co., LLP, Salt Lake City, UT (US)

(21) Appl. No.: 15/188,600

(22) Filed: Jun. 21, 2016

(51) Int. Cl. B60S 3/04; B08B 3/02

(52) U.S. Cl. CPC B60S 3/04; B08B 3/02

(57) ABSTRACT

Contained fluid application systems may be used to wash and disinfect large vehicles and equipment in extreme temperatures and remote locations. One system has a base having a platform, a washing station positioned on the base, an enclosure having an internal chamber, a conduit system connecting a fluid container to spray members, and a heating device that provides heat to the internal chamber and a duct system in the base. The system may recapture fluid and prevent freezing of fluid on the surface of the base while being able to apply washing and disinfecting fluid around the entire perimeter of a large vehicle or equipment in the washing station. The system is a unit that can be deployed rapidly and transported easily due to the unitary base and minimal amount of post-deployment assembly needed.

### TECHNICAL FIELD

The present disclosure generally relates to washing and disinfecting systems for cleaning vehicles and large equipment and specifically relates to a self-contained washing and disinfecting system capable of recirculating air and fluid for continuous operation in low temperature locations and remote locations.

### BACKGROUND

Around the world, diseases are spread by human contact with bacteria- and virus-laden carriers. The spread of disease is particularly concerning in the food and agriculture industry, where outbreaks of disease in livestock or food products can spread as trucks and other vehicles are used to transport animals or meat. Therefore, precautions are taken in the shipping in the food and agriculture industry to prevent and limit the spread of harmful contaminants.

Large vehicles and other equipment used in this industry are, however, difficult to clean and disinfect efficiently. Existing cleaning apparatuses often consist of a series of platforms over which a vehicle may drive. Sprayers positioned below the vehicle wash the vehicle by spraying disinfecting solution onto the lower portions of the vehicle, thereby disinfecting the vehicle where it is sprayed. This process is effective for cleaning lower portions of the vehicle, but upper portions cannot effectively be reached by the cleaning apparatuses due to the height of the vehicles and the inefficient amount of labor required for workers to access the top of the vehicles.

Traditional cleaning equipment is also burdensome to use. Multiple platforms, tanks, hose lines, and related equipment must be transported to remote locations, and thus many workers and vehicles may be required to transport and set up the equipment where it is needed. Additionally, the elevation of platforms used must be carefully planned and accounted for so that the drains and pumps of the system will work properly. As a result, deployment areas may require grading in advance of assembly of the cleaning equipment. The many parts and sections of the equipment are also time-consuming to assemble and test. Consequently, multiple-day installation times are common, and this can lead to delays in transportation of products, vehicles, and equipment. In some cases, businesses may decide to continue operation of equipment that is at risk of spreading disease in order to avoid the extensive wait. The equipment may also be burdensome to use because of wasteful use of disinfectant solution. Many systems have poor and inefficient fluid reclamation systems, and therefore the risk increases that chemical solutions may be undesirably spread to work sites, public drainage systems, and wildlife habitats. Furthermore, harsh weather and low temperatures frequently cause problems with the cleaning equipment since exposed hose lines and pipes frequently freeze up and must be thawed before continuing work.

Accordingly, there is a need for improvements to washing and disinfecting systems for large vehicles and equipment.

### SUMMARY

One aspect of the present disclosure relates to a contained fluid application system for applying fluids to vehicles and/or equipment. The system may comprise a base that includes include a platform, a fluid recapture member, and a plurality of recesses in the platform, with the plurality of recesses providing fluid communication to the fluid recapture member. The system may also include a washing station positioned on the base. The washing station may comprise a plurality of spray members configured to spray vehicles or equipment above the platform, wherein fluid from the plurality of spray members is configured to collect and drain along the plurality of recesses in the platform into the fluid recapture member. The system may also have a container configured to store fluid and a pump system configured to pump fluid from the container to the plurality of spray members of the washing station.

In some arrangements, the pump system may comprise a recapture pump system configured to pump fluid from the fluid recapture member to the container. The fluid recapture member may be positioned at an end of the platform. An enclosure may be positioned on the base, and the container and pump system may be positioned within the enclosure. A heating system may be configured to provide heat into the enclosure.

In some embodiments, the base may further comprise a duct system beneath the platform, and the pump system may comprise fluid conduits extending to the plurality of spray members of the washing station through the duct system. The plurality of spray members may comprise an upper spray system and a lower spray system. The upper spray system may be disconnectable from the lower spray system using at least one valve to limit fluid flow to the upper spray system or it may be disconnectable from the lower spray system by removing conduits of the upper spray system from the lower spray system. The upper spray system may be fluidly connected to the lower spray system by at least one seal nozzle, wherein the at least one seal nozzle may provide fluid drainage from the upper spray system into the lower spray system.

A first portion of the plurality of spray members may be configured to be vertically above vehicles or equipment in the washing station, a second portion of the plurality of spray members are configured to be laterally aside vehicles or equipment in the washing station, and a third portion of the plurality of spray members are configured to be vertically below vehicles or equipment in the washing station. The base may comprise a single integral unit supporting the washing station, the container, the wash pump system, and the recapture pump system. In some arrangements, the system may further comprise a conveyor system at least partially positioned in the fluid recapture member, the conveyor system being operable to convey debris out of the fluid recapture member.

Another aspect of the disclosure relates to a portable fluid application system for applying fluid to vehicles or equipment. The system may comprise a base having a platform with an upper surface and a duct system positioned beneath the platform within the base. A washing station may be positioned on the base, with the washing station comprising a plurality of spray members configured to spray fluids onto vehicles or equipment above the platform. An enclosure may be positioned on the base, with the enclosure having an internal chamber and the internal chamber housing a container for storing fluid. The internal chamber may be connected to the duct system. A conduit system ay provide fluid communication between the container and the plurality of spray members, and a heating device may be configured to provide heat to the internal chamber and the duct system.

The system may also comprise a circulation device configured to circulate heated air through the duct system to heat the upper surface of the platform and at least a portion of the conduit system. The circulation device may be positioned in the duct system. The conduit system may extend at least partially within the duct system, and the heating device may be positioned in the enclosure. The platform may have a plurality of recesses, and the internal chamber may be connected to the duct system between the plurality of recesses.

In another aspect of the disclosure, methods of cleaning vehicles or equipment in low temperature environments are provided. An example method may include providing a fluid application system, with the fluid application system having a base, a platform positioned on top of the base, a plurality of spray nozzles, a fluid container, a conduit system connecting the fluid container to the plurality of spray nozzles, a duct system positioned within the base, and an enclosure housing the fluid container. The method may also include heating air within the enclosure or duct system using a heating device and warming the platform and conduit system by positioning the heated air within the duct system and enclosure.

The method may further comprise circulating the heated air through the duct system and enclosure using a circulation device. The conduit system may be warmed within the duct system. The method may further comprise reclaiming fluid from the platform and depositing the fluid in the fluid container. In some embodiments, the platform comprises a plurality of recesses, with the plurality of recesses being warmed by the heated air within the duct system.

In some embodiments the fluid application system may comprise a secondary enclosure that is connected to the enclosure housing the fluid container. The method may further comprise positioning the heated air within the secondary enclosure by passing the heated air through an opening connecting the secondary enclosure and the enclosure housing the fluid container,

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is an external perspective view of a system of the present disclosure.

FIG. 2 is an alternative external perspective view of the system of FIG. 1,

FIG. 3 is an end view of the enclosure area of the system of FIG. 1 with end doors and walls hidden.

FIG. 4 is a lower perspective view of the system of FIG. 1, with the doors and walls of the enclosure hidden and with the bottom panel of the base hidden.

FIG. 5 is a perspective view of the system of FIG. 1 with part of the upper enclosure hidden and with some walls and the roof of the enclosure hidden.

FIG. 5A is a diagrammatic side section view of an interface between an upper side wash conduit and a lower side wash conduit.

FIG. 6 is a detail view of the enclosure area of FIG. 5.

FIG. 7 is a section view of an end of one of the discharge tubes near the fluid reclamation member.

FIG. 8 shows an external perspective view of another system of the present disclosure.

FIG. 8A shows a detailed view of a control post of the system of FIG. 8.

FIG. 8B shows a detailed view of a sensor post of the system of FIG. 8.

FIG. 9 shows a detailed view of a conveyor system of the system of FIG. 8.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to systems and methods for cleaning large vehicles and equipment at remote locations using a recirculating fluid application system and a heated air circulation system that are implemented on a single, easily-transported platform. In some embodiments, the system may comprise a base having a platform, a fluid recapture member, and a plurality of recesses that provide fluid communication to the fluid recapture member.

The base also has a washing station having a plurality of spray members configured to spray vehicles and/or equipment on the platform. Fluid from the spray members may be collected and drained along the recesses into the fluid recapture member and then pumped and recirculated into the spray system. The spray members may be formed in a structure configured to extend vertically above the position of the washing station so that the top and upper sides of a vehicle or other equipment may be treated with disinfectant spray while positioned at the washing station. Fluid for the spray system may be provided from a fluid reservoir in an enclosure on the base. Fluid in the reservoir may be filled by a pump, and reclaimed fluid may be filtered before refilling the reservoir.

The enclosure on the base may be an insulated enclosure with an internal heat source. The heat source may warm fluids stored in or circulating through the enclosure to prevent them from freezing on the platform or in conduits leading to or away from the enclosure. The base may also include a duct system that allows warm air to circulate beneath the surface of the platform and washing station and thereby inhibit the development of ice and facilitate the movement of liquids across the surface of the platform.

In some embodiments the entire base may be moved together with the washing station and enclosure as a single unit. Thus, post-delivery assembly time and labor may be minimized and optimized. For example, the base may be deposited at the site using a forklift, and the unit may be ready for washing operations within a few hours after being connected to water sources and an enclosure with spray nozzles is assembled for the washing station.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

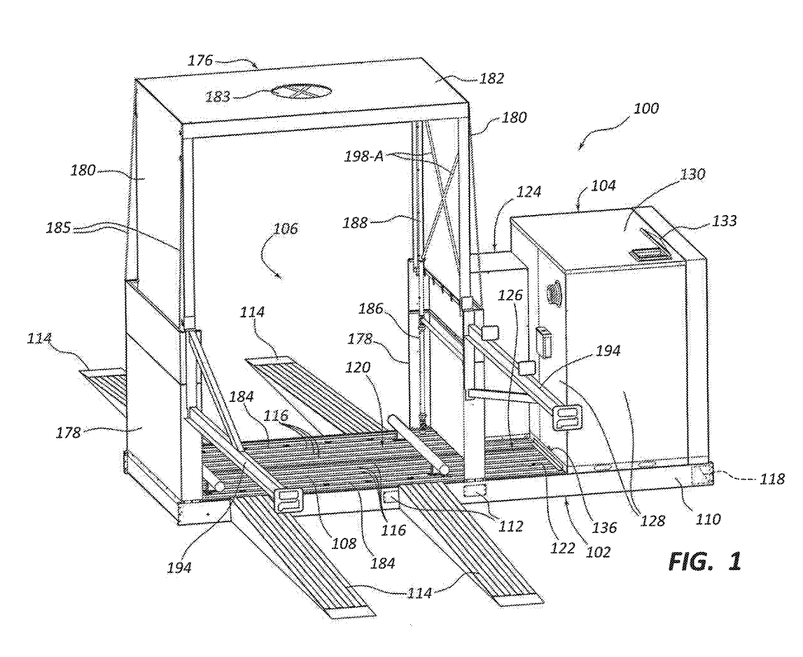

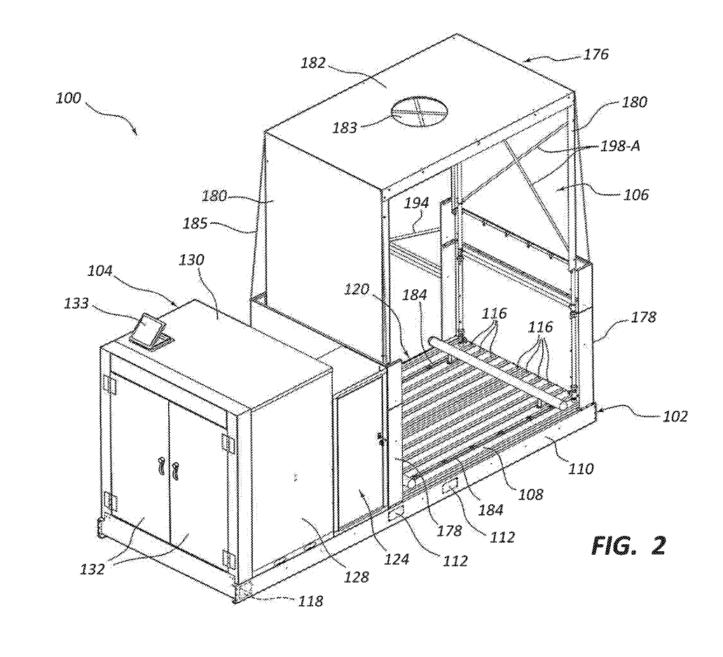

Turning now to the figures in detail, FIGS. 1-2 illustrate a washing and disinfecting system 100 according to an embodiment of the present disclosure. FIG. 1 shows a perspective view from a front side of the system 100, and FIG. 2 shows a perspective view from the opposite side of the system 100. The system 100 may comprise a base 102, an enclosure 104, and a wash station 106. The wash station 106 and enclosure 104 may be positioned at opposite ends of the base 102.

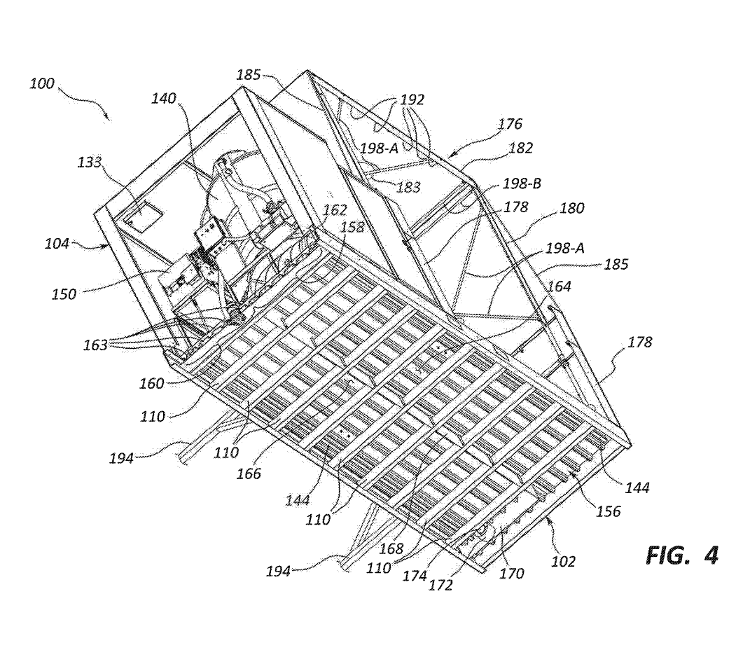

The base 102 may comprise a platform 108. The platform 108 may extend across the length of the base 102 and may be positioned on top of a plurality of supports 110. See also FIG. 4. One or more of the plurality of supports 110 may comprise lift openings 112 that a forklift may use to transport the base 102, enclosure 104, and wash station 106 as a single unit. Wheel ramps 114 may extend away from the base 102 and may lead a vehicle up onto the platform 108 at the wash station 106. The wheel ramps 114 may be positioned on opposite sides of the wash station 106 so that a vehicle may drive or otherwise move over the wash station. 106. In some embodiments, the base 102 may be positioned at least partially sunken below the vehicle driving surface or there may be another type of ramp (e.g., an earthen ramp) at the system 100, in which case a vehicle may access the wash station 106 without having to drive up wheel ramps 114. Thus, wheel ramps may be omitted. Wheel ramps are omitted from the figures after FIG. 1 to improve their readability and to provide an example embodiment of the system 100 that does not have wheel ramps 114.

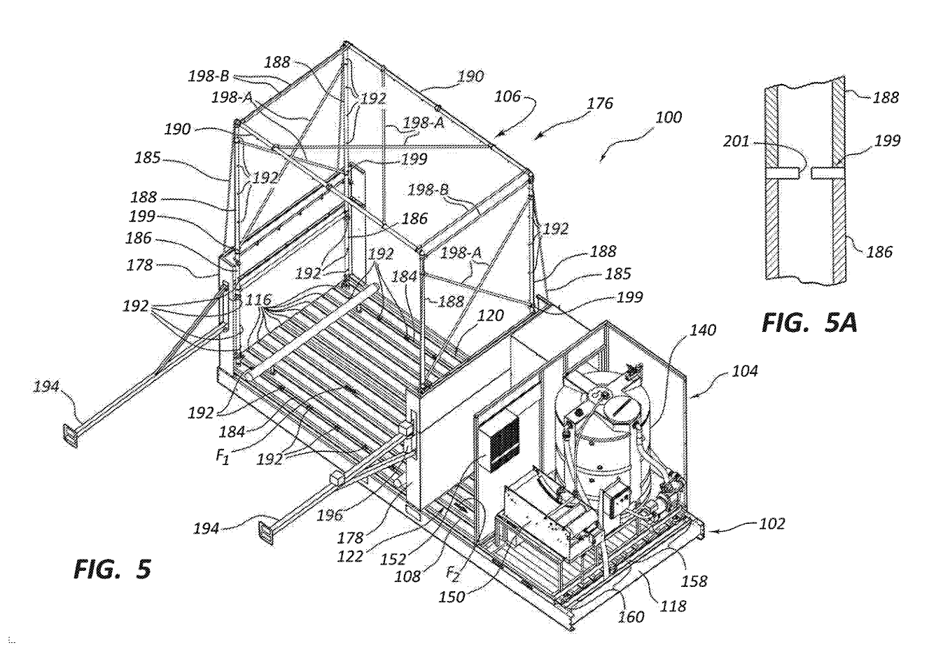

The platform 108 may comprise a plurality of recesses 116 that have an elongated groove shape extending across the length of the base 102 between the wash station 106 and the enclosure 104. The plurality of recesses 116 may extend beneath the enclosure 104 so that fluid in the recesses 116 may flow under the walls of the enclosure 104 to a fluid reclamation member 118 (e.g., gutter) at the end of the base 102 under the enclosure 104. See FIGS. 5-7. Aside from the plurality of recesses 116, the platform 108 may be generally flat and level to stably support the weight of a vehicle or other large equipment. In some embodiments, the platform 108 may be sloped with the wash station 106 being higher than the enclosure 104 upon installation of the system 100 so that fluids may more easily drain toward one end of the platform 108 within the plurality of recesses 116. For example, the platform 108 may be tilted to induce flow toward the fluid reclamation member 118 due to one side of the plurality of supports 110 being positioned on the ground slightly higher than the other side or due to some of the plurality of supports 110 being taller than others even when placed on level ground.

The platform 108 may be generally rectangular with a greater length than width. In an example embodiment, the platform 108 may be about 8 feet wide and about 21 feet long. Thus, the base 102 may be sized to be transported by a flatbed truck. The platform 108 may be generally free of drain holes or openings that would allow fluids to drain through the platform 108. However, in some cases there may be openings in the platform 108 that drain the plurality of recesses 116 into the fluid reclamation member 118 within or under the enclosure 104.

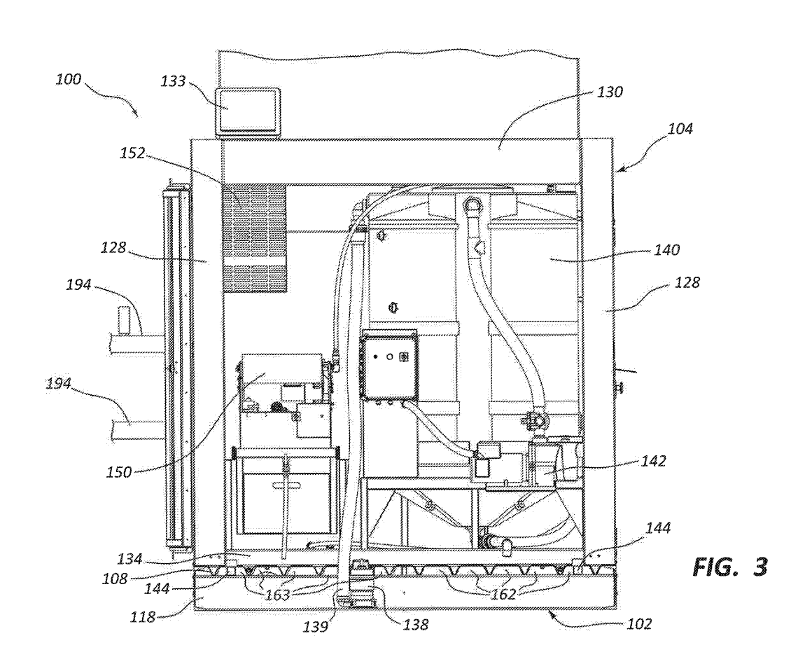

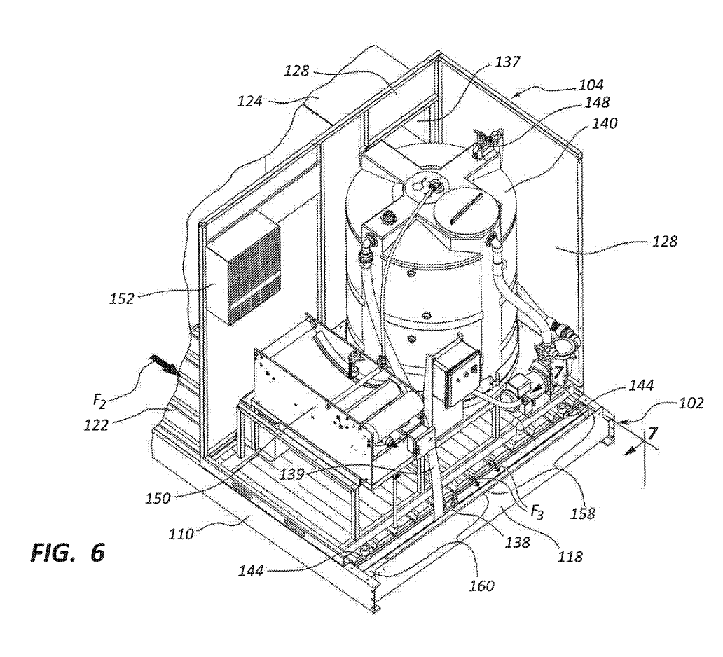

The plurality of recesses 116 may be referred to as corrugations in the surface of the platform 108. Corrugations may form a pattern of repeated undulations that extends across the surface of the platform 108. See FIGS. 3 and 6. The corrugations may also form alternating ridges and grooves on the underside of the platform 108. See FIG. 4. Thus, the plurality of recesses 116 may form channels on the top side of the platform 108 and may form arches on the underside of the platform 108. The channels of the plurality of recesses 116 may be generally V-shaped or truncated V-shaped and straight along a longitudinal direction extending across the top of the platform 108. Some of the plurality of recesses 116 may contain wash head conduits 184, and in some embodiments those recesses 116 may have different sizes or shapes as compared to other recesses 116 in order to accommodate the dimensions of the wash head conduits 184 without preventing fluid from flowing through the recesses 116.

The platform 108 may be divided into a washing portion 120 and a utility portion 122. The washing portion 120 may be positioned under the wash station 106 and may form the bottom surface of the wash station 106. The utility portion 122 may form the rest of the platform. 108, including the portions of the platform 108 that support the enclosure 104, a cabinet 124 (i.e., a secondary enclosure), and an exposed storage area 126. As shown in FIGS. 5-6, fluids may flow along direction F₁ from the washing portion 120 to the utility portion along path F₂ and into the fluid reclamation member 118 along path F₃.

The enclosure 104 may comprise perimeter walls 128, a roof 130, and doors 132 (see FIG. 2). The walls, 128, roof 130, and doors 132 may be insulated so that the enclosure 104 retains heat in its internal chamber. The roof 130 may include a vent 133 that may be used to release excess heat from the enclosure 104. The vent 133 may be manually controlled or may be configured to automatically open to release heat, such as by using a thermostat-controlled motor.

The enclosure 104 may be positioned vertically above a portion of the platform 108 and the fluid reclamation member 118. See FIGS. 3 and 5. Thus, the platform 108 may support the bottom f the enclosure 104 and may be connected to the bottom of the perimeter walls 128. In some arrangements, the bottom of the enclosure 104 may also comprise a base wall 134 that extends horizontally underneath the roof 130. The base wall 134 may also be insulated and/or connected to the platform 108. The plurality of recesses 116 on the platform 108 may extend underneath the base wall 134. See FIGS. 4-6. The perimeter walls 128 of the enclosure 104 may be penetrated by inlets 136 (see FIG. 1) for a water line, fuel line, or similar supplies for the contents of the enclosure 104. In some embodiments, the perimeter wall 128 contacting the cabinet 124 may comprise an opening 137 or passageway into the cabinet 124 so that the contents of the cabinet 124 may be warmed using air from the enclosure 104. An exhaust vent 153 may also be formed in the enclosure 104 for a space heater 152 which is described in further detail below.

The internal chamber of the enclosure 104 may be accessed by opening the doors 132 FIG. 3 illustrates an end view of the system 100 with the doors 132 and other end panels of the enclosure 104 removed to reveal the contents of the enclosure 104. FIG. 4 shows the underside of the system 100 with the doors 132 and end panels of the enclosure 104 removed and with a bottom panel of the base 102 removed to reveal the plurality of supports 110 and a duct system 156 which is described in further detail below. FIG. 5 shows a perspective view of the system 100 with the roof 130, a perimeter wall 128, the doors 132, and the wall portions surrounding the doors 132 removed. FIG. 6 is a detail view of the enclosure area of FIG. 5. FIG. 6 is a side view of the bottom of the enclosure 104 with a perimeter wall 128 removed. Reference will be made to these figures in connection with the components and function of the enclosure 104 herein.

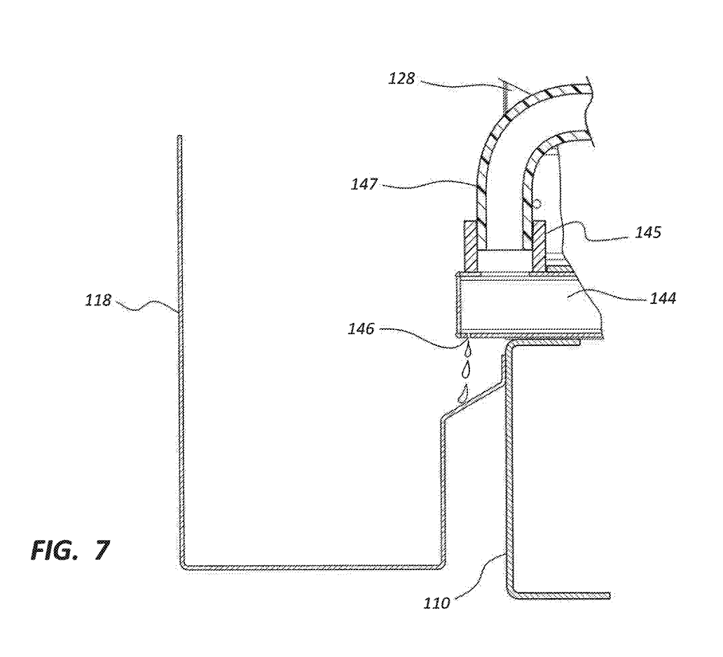

The fluid reclamation member 118 may be positioned connected to the base 102 and within the enclosure 104 beneath the doors 132. See FIGS. 6-7. Thus, the contents of the fluid reclamation member 118 may be easily observed, accessed, and cleaned upon opening the doors 132. Additionally, when the doors 132 are closed, the fluid reclamation member 118 may remain warm due to being enclosed therein. A sump pump 138 may be positioned in the fluid reclamation member 118 and may pump fluid from the fluid reclamation member 118 to a solution tank 140 in the enclosure 104 via a return line 139. A low pressure pump 142 may be connected to an outlet of the solution tank 140 and may be used to pump fluid solution from the solution tank 140 into a conduit system having discharge tubes 144 that extend under the platform 108 and connect to the wash station 106. A pump hose 147 between the low pressure pump 142 and a discharge tube 144 is shown in FIG. 7. The sump pump 138, low pressure pump 142, and their related lines and power sources may be collectively referred to as a pump system.

The ends of the discharge tubes 144 may comprise small drain openings 146 that open over the fluid reclamation member 118. See FIG. 7. The drain openings 146 may be positioned in the bottom surfaces of the discharge tubes 144 or in lateral or end surfaces of the discharge tubes 144. The drain openings 146 may be small enough that they do not significantly divert fluid from the discharge tubes 144 into the fluid reclamation member 118 when fluid is pumped into the discharge tubes 144 to flow to the wash station 106. However, they may still allow excess fluid in the discharge tubes 144 to slowly drain out into the fluid reclamation member 118 while and after fluid is pumped through the discharge tubes 144. Thus, the discharge tubes 144 may be filled with fluid via top openings 145 and pump hoses 147 connected to a pump (e.g., the low pressure pump 142) and may drain via the drain openings 146, as shown in FIG. 7.

In some embodiments, the drain openings 146 may be fitted with removable orifices such as, for example, threaded nozzles. The removable orifices may allow the user to control the flow of fluid out of the drain openings 146 and may allow the user to remove the nozzles for repair or cleaning of debris and obstructions. During warm weather, the nozzles may be closed or replaced with plugs.

The solution tank 140 may be a large tank used to retain and contain a supply of disinfectant solution. For example, the solution tank 140 may be a 500-gallon tank. The solution tank 140 may be filled through the sump pump 138 and return line 139 and/or a fill valve 148. See FIG. 6. The sump pump 138 may supply pre-mixed solution to the solution tank 140 after the solution has drained from the platform 108 (via path F₃) into the fluid reclamation member 118. The fill valve 148 may be connected to a source of disinfectant concentrate (e.g., a concentrate tank (not shown) in the cabinet 124) and a water line (e.g., water provided from an external source via the inlets 136). The fill valve 148 may be a Venturi device used to supply a predetermined ratio of concentrate and water into the solution tank 140. A solenoid or other sensor device may be used to automatically control the solution level in the solution tank 140 to avoid over-filling the tank, under-filling, or waste.

A filter system 150 may be positioned in the enclosure 104 to keep the solution (especially solution in the solution tank 140) free of contaminants. The filter system 150 may receive solution from the bottom of the solution tank 140, where debris and contaminants frequently settle, then filter the solution and provide the solution back to the fluid reclamation member 118 for reuse. Thus, the filter system 150 may help extend the useful life of the solution by limiting the amount of debris, dirt, and other contaminants from clogging the discharge tubes 144 or other fluid bearing conduits in the system 100. In an example embodiment, the filter system 150 may comprise paper media onto which the solution is sprayed. Liquid solution passes through the paper media, but solids accumulate on the surface as they are unable to pass through. As contaminants build up on the paper media, the filter system 150 may sense blockage of the paper media or increased weight of the media and then automatically move clean paper media into place to continue filtration. Filtered solution may drain into the fluid reclamation member 118 and then pumped back into the solution tank 140 by the sump pump 138.

A space heater 152 may provide heat to the internal chamber of the enclosure 104. The space heater 152 may be an electrically-powered heater or a fuel-burning heater, such as, for example, a heater that operates using propane, natural gas, charcoal, or another solid, liquid, or gaseous fuel. The fuel source for the space heater 152 may be internal or external to the space heater 152. For example, a fuel tank may be stored on the platform 108, in the enclosure 104, or in the cabinet 124. The main heat output of the space heater 152 may provide heated air to the internal chamber of the enclosure 104. Exhaust of the space heater 152 may exit through a heater exhaust vent 153 and away from the enclosure 104. In some embodiments the heater exhaust vent 153 may also include a fan or motor,

Operating the space heater 152 may directly prevent freezing of the fluids in the solution tank 140 by warming the enclosure 104 as a whole. The space heater 152 may also prevent freezing of fluids in the discharge tubes 144 and other lines connected to the solution tank 140 by either warming the lines themselves within the enclosure 104 with heated air (e.g., return line 139) or by the heated solution from the solution tank 140 being provided to those lines and thereby distributing heat to the lines via the solution.

The internal chamber of the enclosure 104 may be fluidly connected to a duct system 156 positioned in the base 102 below the platform 108. See FIG. 4, which shows the underside of the base 102 with its bottom panel removed to show the interior of the duct system 156; see also FIG. 6. Thus, air in the enclosure 104 may flow into the duct system 156 and vice versa. In some arrangements the air in the duct system 156 may be contained by the bottom panel of the base 102, and in some arrangements the bottom panel may be omitted and air may be contained by contact between the plurality of supports 110 to a flat surface underneath the base 102. The flat surface may be, for example, a leveled or paved ground area.

The duct system 156 may extend along the length of the base 102 underneath the enclosure 104 and wash station 106 around the plurality of supports 110. The duct system 156 may comprise an inlet 158 opening into the internal chamber of the enclosure 104 and an outlet 160 opening into the internal chamber of the enclosure 104. See FIGS. 4-6. The inlet 158 may comprise a plurality of adjacent openings 162 that each link a first portion 164 of the duct system. 156 to the internal chamber of the enclosure 104, and the outlet 160 may comprise a plurality of adjacent openings 163 that each link a second portion 166 of the duct system 156 to the internal chamber. See FIGS. 3-4. The first and second portions 164, 166 of the duct system 156 may be separated by each other by a first dividing wall 168 and a second dividing wall 170.

The first and second portions 164, 166 of the duct system 156 may each be generally rectangular or L-shaped when viewed from vertically above or below the base 102. In FIG. 4, the first portion 164 is L-shaped and the second portion 166 is rectangular shaped. The discharge tubes 144 may each extend longitudinally along the base 102 within the first and second portions 164, 166. The heated air from the enclosure 104 may fill the first and second portions 164, 166 and thereby keep the discharge tubes 144 from being subjected to freezing cold air. Accordingly, when the system 100 is positioned in remote locations and exposed to extreme weather, the heated air of the space heater 152 may be distributed underneath the platform 108. Heated air in the duct system 156 may preserve the temperature of solution flowing into the wash station 106 via discharge tubes 144 and may warm cooled fluids in the discharge tube 144 after the pumps are turned off and the discharge tube 144 is draining into the fluid reclamation member 118. The heated air may also raise the temperature of the platform 108 so that fluids on top of the platform will not be frozen.

One or more of the dividing walls 168, 170 may comprise an opening 172 in which a circulation device 174 may be positioned. The circulation device 174 may be an air fan that may be operated to draw air from one of the first and second portions 164, 166 of the duct system 156 into the other. Thus, the circulation device 174 may help circulate warmed air from the inlet 158 to the outlet 160 or vice versa. The circulation device 174 may be positioned at an opposite end of the base 102 from the enclosure 104. Accordingly, the circulation device 174 may help prevent stagnation of air in the duct system 156 and assist any fans or other circulation provided by the space heater 152 by providing additional air movement where there would otherwise be inherent inefficiency. Having the circulation device 174 under the wash station 106 therefore keeps the platform 108 more evenly heated, particularly at the wash station 106 where the base 102 is exposed to a proportionally large amount of moisture and fluids.

Arches in the underside of the platform 108 may provide air passages that are continuous across and over the top of the plurality of supports 110 in the base 102. These arches may form the openings for 162, 163 for the inlets 158, 160 near the fluid reclamation member 118. Thus, air may flow over the plurality of supports 110 throughout the duct system 156 without the plurality of supports 110 having their own vent passages. As a result, the structural strength of the base 102 may not be compromised by the presence of the duct system 156. Furthermore, the base 102 may require less modification from existing structures to be adapted for use as the base 102 of the system since no cuts in the plurality of supports 110 are needed to accommodate the duct system 156.

Referring now to FIGS. 1, 2, 4, and 5, the wash station 106 may comprise an station enclosure 176 flanked by enclosure walls 178, 180 and a roof 182. A plurality of wash head conduits 184, 186, 188, 190 may be routed around the station enclosure 176 where a vehicle may pass through the station enclosure 176. See FIG. 5. Which shows the wash station 106 without the upper enclosure walls 180 and roof 182. The wash head conduits 184, 186, 188, 190 may comprise floor wash head conduits 184 on each side of the wash station 106 contacting or running along the upper surface of the platform 108, lower side wash head conduits 186 and upper side wash head conduits 188 laterally to the sides of the vehicle bay area and extending vertically upward from the platform 108, and roof wash head conduits 190 positioned vertically above the vehicle bay area and extending horizontally between the upper side wash head conduits 188. Thus, the floor wash head conduits 184 may be configured to be vertically below vehicles or equipment in the wash station 106, the lower and upper side wash head conduits 186, 188 may be positioned laterally aside vehicles or equipment in the wash station 106, and the roof wash head conduits 190 may be configured to be vertically above vehicles or equipment in the wash station 106.

The wash head conduits 184, 186, 188, 190 may be fluidly connected to the discharge tubes 144 and thereby receive solution from the solution tank 140 to dispense it through nozzles 192 positioned on the wash head conduits 184, 186, 188, 190 and spaced throughout the wash station 106. Some of the nozzles 192 are not labeled in the figures, but the nozzles 192 may be distributed across the lengths of the wash head conduits 184, 186, 188, 190 and may be directed toward the interior of the wash station 106. Some of the nozzles 192 may dispense solution upward from the floor wash head conduits 184 to apply solution to the bottom surfaces of a vehicle, some of the nozzles 192 may dispense solution laterally from the lower and upper side wash head conduits 186, 188 to apply solution to the lower and upper side surfaces of a vehicle, and some of the nozzles 192 may dispense solution in a generally downward direction from the roof wash head conduits 190 to apply solution to the top surfaces of a vehicle. In one embodiment, the nozzles 192 may be aimed at about 30 degrees from a vertical direction so that they may cover the front and rear of a vehicle that moves through the wash station 106. In other configurations, the nozzles 192 may be aimed directly downward. Accordingly, a vehicle in the wash station 106 may be disinfected by the spray around its entire outer perimeter. As the vehicle proceeds through the wash station 106, the entire length of the vehicle may pass through the wash station 106. Thus, the perimeter of the vehicle may be sprayed along the entire length of the vehicle for a thorough and effective cleaning and disinfecting of the outer surfaces of the vehicle along its entire length as it progresses through the wash station 106.

The floor wash head conduits 184 may be positioned below the highest surfaces of the platform 108 within some of the plurality of recesses 116 of the platform 108. See FIGS. 1, 3 and 5. Accordingly, when a vehicle passes over the wash station 106, the floor wash head conduits 184 may be below the upper surfaces of the platform 108 that contact tires or other parts of the vehicle that may come into contact with the base 102. This configuration may protect the floor wash head conduits 184 from damage due to the weight of the vehicles being applied to the base 102. This configuration may also facilitate recollection of dispensed solution that comes from nozzles 192 on the floor wash head conduits 184 since fluid dripping from those nozzles 192 may fall directly into the recesses 116 and therefore may be carried more directly back to the fluid reclamation member 118.

One or more sensors 194 may extend from one or more of the enclosure walls 178, 180. The sensors 194 may be used to detect the presence of a vehicle approaching the wash station 106 before it reaches the platform 108. For example, the sensors 194 may comprise an infrared sensor configured to detect the presence of a vehicle adjacent to the sensor. When one or more sensor 194 detects the presence of a vehicle, the system 100 may preemptively begin operating the pumps and fluid dispensing systems to begin spraying solution from the nozzles 192 at the necessary level for effective cleaning and disinfecting of even the very front of the vehicle. As the sensors 194 register that the rear of the vehicle has passed the extensions of the sensors 194, the spray system may continue to operate on a timer to ensure that the back of the vehicle is also cleaned before the spray is turned off.

The wash station 106 may have a modular construction configured to enhance the portability of the system 100 and to ensure that large vehicles may be washed in the wash station 106. In one aspect, the modular construction may include a disassemblable conduit system. The wash head conduits 184, 186, 188, 190 may be disconnected from each other and configured so that only certain combinations of wash head conduits 184, 186, 188, 190 are active as needed. For example, some of the wash head conduits 184, 186, 188, 190 may be detached from others by entirely removing some of the conduits from the system 100. In one instance, the upper side wash head conduits 188 and roof wash head conduits 190 may be disassembled and taken off of the system 100, leaving behind only the floor wash head conduits 184 and lower side wash head conduits 186 to clean a vehicle or equipment.

In some embodiments, the floor wash head conduits 184 and lower side wash head conduits 186 may have their internal flow stopped from reaching the upper side wash head conduits 188 and roof wash head conduits 190 by a valve 196 or network of valves. The valve 196 may he an electric valve such as a solenoid-operated valve or a ball valve. The valve 196 may be closed so that solution may only be dispensed from the floor and lower side wash head conduits 184, 186 without being simultaneously dispensed from the upper side and roof wash head conduits 188, 190. The valve 196 may also cut off flow to the upper side and roof wash head conduits 188, 190 when they are disconnected from the lower side wash head conduits 186.

The valve 196 may be positioned between only one set of pipes of the upper side wash head conduits 188 and the lower side wash head conduits 186. The valve 196 may, however, cut off fluid flow to all of the upper side wash head conduits 188 when it is closed because the other connections between the upper side wash head conduits 188 and lower side wash head conduits 186 may have seal nozzles 199 1 installed between them. FIG. 5A shows a section view of one of the connections between the upper and lower side wash head conduits 188, 186 having a seal nozzle 199. Each seal nozzle 199 may comprise an aperture 201 having a substantially narrower width than the width of the lower side wash head conduits 186. The aperture 201 of each seal nozzle 199 may significantly limit fluid flow from the upper side wash head conduits 188 into the lower side wash head conduits 186 when the valve 196 is open, yet the aperture 201 may allow drainage of fluid from the upper side wash head conduits 188 into the lower side wash head conduits after spraying is complete or when the valve 196 is closed. Thus, fluid in the upper side wash head conduits 188 may be less likely to freeze in place since it is able to automatically drain away. Additionally, when the upper side wash head conduits 188 are not wanted (e.g., the valve 196 is closed during washing) or when the upper side wash head conduits 188 and other upper components are removed from the lower side wash head conduits 186, the seal nozzles 199 may limit flow of fluid upward into those conduits 188 or out of the apertures 201.

The upper side wash head conduits 188 and roof wash head conduits 190 may have their positioning reinforced by cross members 198. Some of the cross members 198-A may form criss-crossing X-shapes between sides of the wash station 106. Some of the cross members 198-B may also extend horizontally between the upper side wash head conduits 188 and roof wash head conduits 190. Lower ends of the upper side wash head conduits 188 may also be supported by lower enclosure walls 178 of the station enclosure 176.

The upper side and roof wash head conduits 188, 190 may be disconnected from the floor and lower side wash head conduits 184, 186. For example, they may be disconnected to facilitate storage or transportation of the system 100. Disconnecting the upper side and roof wash head conduits 188, 190 may allow the system 100 to have a lower vertical height that may be more manageable for movement on a flatbed truck or comparable delivery vehicle. Disconnecting the upper side and roof wash head conduits 188, 190 may also help protect them from damage or freezing during transport since they are more exposed than the floor and lower side wash head conduits 184, 186.

When the upper side and roof wash head conduits 188, 190 are removed, the roof 182 and upper enclosure wall 180 of the station enclosure 176 may also be removed from the lower enclosure wall 178. The roof 182 and upper enclosure wall 180 may be formed as a single integral piece or sheet positioned on the upper side and roof wash head conduits 188, 190. The roof 182 and upper enclosure wall 180 may be connected to the lower enclosure wall 178 using a plurality of hooks and loops or elastic cords. Guy wires 185 may he used to connect the ends of the cross members 198-B to the lower enclosure wall 178. The guy wires 185 may improve stability of the upper enclosure but may also be detachable from the lower enclosure wall 178. Thus, the roof 182 and upper enclosure wall 180 may be quickly attached or detached from the lower enclosure wall 178 for rapid deployment and break-down. The roof 182 and upper enclosure wall 180 may be a soft cover for ease of storage and transportation. In some embodiments, the roof 182 may be a solid expanse of material, but in other embodiments, such as that shown in FIGS. 1, 2, and 4, the roof 182 may comprise an opening 183 configured to allow rainwater and snow to pass through the roof 182 rather than collecting on the soft material of the roof 182. The upper enclosure wall 180 and roof 182 may help contain fluid spray and mist coming from the upper side and roof wash head conduits 188, 190. Typically, the spray and mist is not sent directly upward into the roof 182, and therefore it is unlikely that a large amount of spray and mist will pass through the opening 183. Furthermore, the upper side and roof wash head conduits 188, 190 may be used when large vehicles need washing and disinfecting, yet they may be removed or not assembled upon deployment of the system 100 when only smaller or shorter vehicles need to be washed and disinfected.

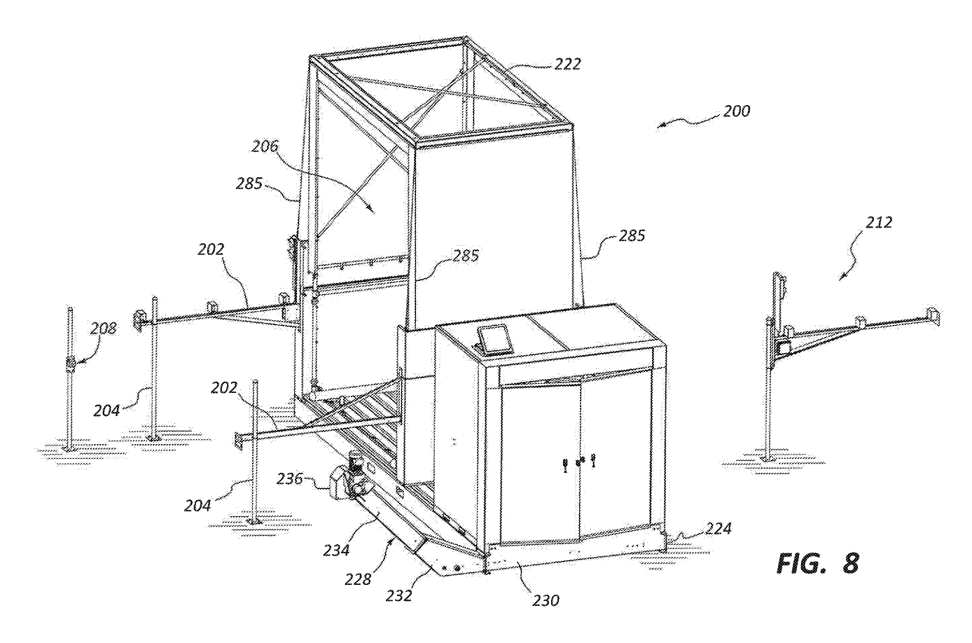

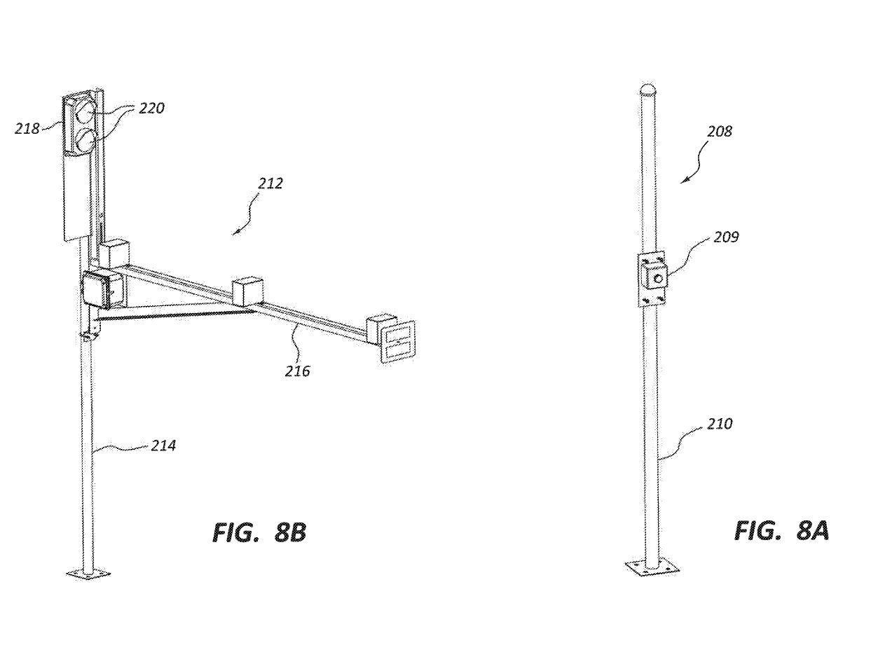

Another aspect of the present disclosure relates to a sensor and control system for detecting vehicles being washed or disinfected. FIG. 8 shows a perspective view of a washing and disinfecting system 200 similar to the system 100 of FIG. 1. In this system 200, the sensor apparatus comprises sensor bars 202 that may be supported by posts 204. The sensor bars 202 may be equivalent to the sensors 194 of system 100, wherein they may be configured to detect the presence of a vehicle approaching or leaving the wash station 206 of the system 200. The posts 204 may be anchored to the ground around the system 200. Thus, the posts 204 may provide additional strength to the sensor bars 202 and may improve their visibility for vehicle drivers. Sensor bars 202 may also be attached to the opposite side of the wash station 206 and may therefore provide sensors that detect vehicles approaching from the other direction relative to the wash station 206. Thus, sensor bars 202 may be positioned on one or both sides of the wash station 206.

The system 200 may also include a control apparatus 208. See also FIG. 8A. The control apparatus 208 may be a remote control point from which the flow of fluids through the system 200 may be controlled. Thus, the control apparatus 208 may comprise a control feature (e.g., a control panel 209 mounted on a post 210) having an actuator that may control the flow of fluid through the system 200. In some embodiments, the control apparatus 208 may be used by a driver of a vehicle to open or close a valve (e.g., valve 196) and thereby control whether the system 200 sprays fluid through upper side wash head conduits (e.g., 188) when the vehicle passes through the wash station 206. With the control apparatus 208 positioned remotely from the wash station 206, the operator (e.g., driver) may control the valve, fluid flow rate, and/or other features of the system 200 before the vehicle is detected by the sensor bars 202 and the system 200 starts pumping fluids. The remote positioning of the control apparatus 208 may also limit the operator's exposure to sprayed fluids if the system 200 is operating when the operator accesses the control apparatus 208. For example, a driver may beneficially avoid getting the interior of the vehicle wet as a result of exposure to airborne spray.

FIGS. 8 and 8B show views of a remote sensor apparatus 212 that may be used in connection with system 200. The remote sensor apparatus 212 may comprise a post 214 configured to support a remote sensor bar 216 and an indicator 218. The remote sensor bar 216 may be substantially similar to the sensor bars 202 connected to the wash station 206 and thus may be used to detect a vehicle as it approaches or leaves the wash station 206. With the remote sensor bar 216, the system 200 may accommodate longer vehicles due to the sensor bar 216 being positioned further from the wash station 206. The system 200 may also detect vehicles earlier and at a greater distance as they approach or leave the wash station 206. Accordingly, if the system 200 requires time to start up before a vehicle is properly able to be washed or disinfected, the earlier detection of the vehicle may allow the vehicle to approach and pass through the wash station 206 more smoothly and continuously rather than having to be detected and wait for the system 200 to be ready for the vehicle to enter the wash station 206. This may also allow vehicles to move more quickly as they approach and pass through the wash station 206, thereby improving the number of vehicles that can be washed or disinfected over time.

The remote sensor apparatus 212 may also comprise an indicator 218. The indicator 218 may comprise a lighted portion or a sign used to direct the operator of a vehicle through the wash station 206. For example, the indicator 218 may comprise a plurality of lights 220 (e.g., a green light and a red light) to help guide a driver concerning whether to go or stop. In some embodiments, the indicator 218 may comprise an audible indicator such as a speaker configured to provide audio cues to vehicle operators and thereby guide them through the wash station 206 at appropriate times. In some arrangements, the indicator 218 may be positioned mounted to the wash station 206 enclosure.

The wash station 206 of system 200 may comprise an open top. The open top may comprise a rigid frame 222 running around the perimeter of the wash station 206. The rigid frame 222 may be connected to guy wires 285 that help keep the rigid frame 222 positioned relative to the wash station 206. Thus, wash station 206 may comprise fabric or plastic sheeting sidewalls and an open top surrounding by the frame 222. The frame 222 may comprise a rigid material such as metal or composite. Thus, the guy wires 285 may be more securely anchored to the frame 222 in comparison to an anchor connected to a fabric or plastic sheet. The open top may also allow fluids and mist to settle downward onto the system 200 for collection by the gutter or reclamation member 224.

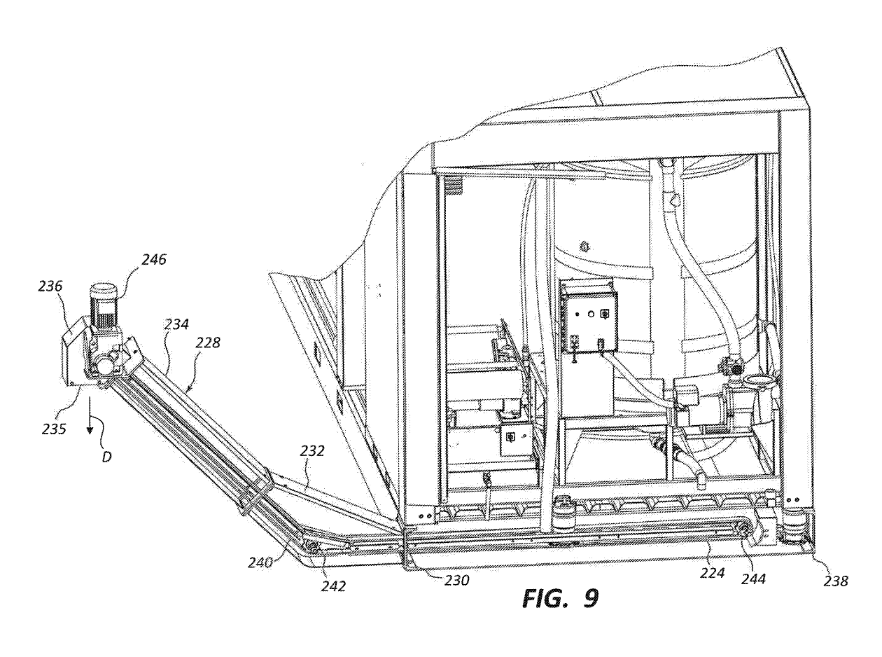

Another aspect of the present disclosure relates to a cleaning system 226 for clearing debris from the gutter or reclamation member 224 of the system 200. FIGS. 8 and 9 show that the cleaning system 226 may include a reclamation member 224 and an elevated conveyor system. 228. The reclamation member 224 and conveyor system 228 have their side panels removed in FIG. 9 to show their internal workings. The conveyor system 228 may be connected to an end portion 230 of the reclamation member 224. The end portion 230 may open into a transition enclosure 232 at the base of the conveyor system 228. The transition enclosure 232 may be connected to a ramp enclosure 234 which is connected to a drive and release enclosure 236. The ramp enclosure 234 may extend at an upward angle from the transition enclosure 232. Thus, the transition enclosure 232 may provide a transition between the horizontally-oriented reclamation member 224 and the angled ramp enclosure 234. Heated air from the rest of the washing and disinfecting system 200 may circulate through the conveyor system 228 to avoid freezing fluids that are carried therein. Thus, the conveyor system 228 may provide an additional enclosure for heated air to travel. The end of the drive and release enclosure 236 may have an opening 235 that permits air and debris to escape from the conveyor system 228, but the size of the opening 235 may be minimized to prevent gusts of wind or other air drafts from effectively cooling the interior of the system 200. Additionally, the angles of the opening 235 and the ramp enclosure 234 may limit the flow of cool air into the system 200 since the air flow would need to change directions multiple times in order to infiltrate and cool the air within the enclosure and reclamation member 224. For example, the air would need to change direction of flow at least once at the opening 235, once at the top of the ramp enclosure 234, and once at the bottom of the ramp enclosure 234.

The conveyor system 228 may also comprise a conveyor belt or track 240 extending through the conveyor system 228 from the drive and release enclosure 236 to the terminal end 238 of the reclamation member 224. The track 240 may be guided by wheels or gears 242, 244. When large debris passes into the reclamation member 224, the debris may fall and collect onto the track 240 and fluids may collect generally in the bottom of the reclamation member 224. A motor 246 may drive the track 240 so that its top surface advances from the terminal end 238 of the reclamation member 224 toward the drive and release enclosure 236. As the track moves 240 and collected debris is moved upward through the ramp enclosure 234, debris may remain on the track 240 while fluids may run off toward the reclamation member 224. Thus, the amount of fluids that reach the drive and release enclosure 236 may be reduced. The track 240 turns around at the drive and release enclosure 236 to proceed back through the ramp enclosure 234, and debris and sludge left on the track 240 may fall off at that point into a collection tank in the direction of arrow D in FIG. 9. Using the conveyor system 228 may improve the quality of reclaimed fluids in the washing and disinfecting system 200 by removing large particulate matter in the fluids so that it can be filtered and cleaned more efficiently by the rest of the system. 200 dedicated to that purpose. Additionally, the conveyor system 228 may reduce the amount of labor needed to keep the reclamation member 224 clean due to the track 240 automatically moving debris out of the reclamation member 224.

According to another aspect of the disclosure, a method for cleaning vehicles or equipment in low temperature environments is provided. The method may comprise providing a fluid application system, such as, for example, system 100 or 200. The fluid application system may comprise a base, a platform positioned on top of the base or that is part of the base, a plurality of spray nozzles, a fluid container, a conduit system connecting the fluid container to the plurality of spray nozzles, a duct system positioned within the base, and an enclosure housing the fluid container. The method may also include heating air within the enclosure or duct system using a heating device and warming the platform and conduit system by positioning the heated air within the duct system and enclosure. The duct system may extend underneath the platform and directly below at least some of the plurality of spray nozzles.

The heated air may be circulated through the duct system and enclosure using a circulation device. For example, the circulation device may be a fan that propels heated air through the duct system by drawing air into the duct system through an inlet formed between the duct system and the enclosure and pushing air out of the duct system through an outlet formed between the duct system and the enclosure. Accordingly, the heated air may be distributed throughout the base, and the platform may be heated to a temperature sufficient to prevent freezing of washing and/or disinfecting fluids in low temperature environments.

The method may also include warming or heating the conduit system within the duct system. For example, the conduit system may be positioned within the duct system and the heated air may be directly warmed by the air in the duct system. Alternatively, the conduit system may be positioned adjacent and external to the duct system but warmed by conduction or other heat transfer through the duct system to the conduit system. For example, the conduit system may comprise the floor wash head conduits 184 that are warmed indirectly by air in the duct system in base 102 that warms a platform 108 to which the floor wash head conduits 184 are attached.

These methods may also include reclaiming fluid in the platform and depositing the fluid in the fluid container. For example, reclaiming the fluid may comprise collecting fluid in a plurality of recesses or channels in the platform and allowing the fluid to run into a collection member such as a gutter or reclamation member 224. The recesses or channels may be warmed by heated air within the duct system. Depositing the fluid in the fluid container may comprise pumping the fluid into the container using a pump configured to draw fluid from the collection member and to pump it back into the fluid container. Part of this process may include filtering the reclaimed fluid using a filtration system before it is pumped into the container.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A contained fluid application system for applying fluids to vehicles or equipment, the system comprising:
a base, the base comprising:
a platform;
a fluid recapture member;
a plurality of recesses in the platform, the plurality of recesses providing fluid communication to the fluid recapture member;
a washing station positioned on the base, the washing station comprising a plurality of spray members configured to spray vehicles or equipment above the platform, wherein fluid from the plurality of spray members is configured to collect and drain along the plurality of recesses in the platform into the fluid recapture member;
a container configured to store fluid;
a pump system configured to pump fluid from the container to the plurality of spray members of the washing station.

2. The contained fluid application system of claim 1, wherein the pump system comprises a recapture pump system configured to pump fluid from the fluid recapture member to the container.

3. The contained fluid application system of claim 1, wherein the fluid recapture member is positioned at an end of the platform.

4. The contained fluid application system of claim 1, further comprising an enclosure positioned on the base, wherein the container and the pump system are positioned within the enclosure.

5. The contained fluid application system of claim 4, further comprising a heating system configured to provide heat into the enclosure.

6. The contained fluid application system of claim 1, wherein the base further comprises a duct system beneath the platform, and the pump system comprises fluid conduits extending to the plurality of spray members of the washing station through the duct system.

7. The contained fluid application system of claim 1, wherein the plurality of spray members comprises an upper spray system and a lower spray system, the upper spray system being disconnectable from the lower spray system using at least one valve to limit fluid flow to the upper spray system.

8. The contained fluid application system of claim 1, wherein the plurality of spray members comprises an upper spray system and a lower spray system, the upper spray system being fluidly connected to the lower spray system by at least one seal nozzle, the at least one seal nozzle providing fluid drainage from the upper spray system into the lower spray system.

9. The contained fluid application system of claim 1, wherein the plurality of spray members comprises an upper spray system and a lower spray system, the upper spray system being disconnectable from the lower spray system by removing conduits of the upper spray system from the lower spray system.

10. The contained fluid application system of claim 1, wherein a first portion of the plurality of spray members are configured to be vertically above vehicles or equipment in the washing station, a second portion of the plurality of spray members are configured to be laterally aside vehicles or equipment in the washing station, and a third portion of the plurality of spray members are configured to be vertically below vehicles or equipment in the washing station.

11. The contained fluid application system of claim 1, wherein the base comprises a single integral unit supporting the washing station, the container, and the pump system.

12. The contained fluid application system of claim 1, further comprising a conveyor system at least partially positioned in the fluid recapture member, the conveyor system being operable to convey debris out of the fluid recapture member.

13. A portable fluid application system for applying fluid to vehicles or equipment, the system comprising:
a base, the base comprising:
a platform having an upper surface;
a duct system positioned beneath the platform within the base;
a washing station positioned on the base, the washing station comprising a plurality of spray members configured to spray fluids onto vehicles or equipment above the platform;
an enclosure positioned on the base, the enclosure having an internal chamber, the internal chamber housing a container for storing fluid, the internal chamber being connected to the duct system;
a conduit system providing fluid communication between the container and the plurality of spray members;
a heating device configured to provide heat to the internal chamber and the duct system.

14. The portable fluid application system of claim 13, further comprising a circulation device configured to circulate heated air through the duct system to heat the upper surface of the platform and at least a portion of the conduit system.

15. The portable fluid application system of claim 14, wherein the circulation device is positioned in the duct system.

16. The portable fluid application system of claim 13, wherein the conduit system extends at least partially within the duct system.

17. The portable fluid application system of claim 13, wherein the heating device is positioned in the enclosure.

18. The portable fluid application system of claim 13, wherein the platform has a plurality of recesses, and the internal chamber is connected to the duct system between the plurality of recesses.

19. A method of cleaning vehicles or equipment in low temperature environments, the method comprising:
providing a fluid application system, the fluid application system having a base, a platform positioned on top of the base, a plurality of spray nozzles, a fluid container, a conduit system connecting the fluid container to the plurality of spray nozzles, a duct system positioned within the base, and an enclosure housing the fluid container;
heating air within the enclosure or duct system using a heating device;
warming the platform and conduit system by positioning the heated air within the duct system and enclosure.

20. The method of claim 19, further comprising circulating the heated air through the duct system and enclosure using a circulation device.

21. The method of claim 19, wherein the conduit system is warmed within the duct system.

22. The method of claim 19, further comprising reclaiming fluid from the platform and depositing the fluid in the fluid container.

23. The method of claim 19, wherein the platform comprises a plurality of recesses, the plurality of recesses being warmed by the heated air within the duct system,

24. The method of claim 19, wherein the fluid application system comprises a secondary enclosure, the secondary enclosure being connected to the enclosure housing the fluid container, and further comprising positioning the heated air within the secondary enclosure by passing the heated air through an opening connecting the secondary enclosure and the enclosure housing the fluid container.
